(19) United States
(12) Patent Application Publication
(10) Pub. No.: US 2016/0037810 A1
(43) Pub. Date: Feb. 11, 2016

(54) COFFEE CHERRY PARTICULATES AND METHODS FOR THEIR PREPARATION

(71) Applicant: EMPIRE TECHNOLOGY DEVELOPMENT LLC, Wilmington, DE (US)

(72) Inventors: Daniel Alderic BELLIVEAU, Bellevue, WA (US); Scott Allen James MCMARTIN, Seattle, WA (US)

(21) Appl. No.: 14/774,095

(22) PCT Filed: Dec. 20, 2013
(86) PCT No.: PCT/US13/77207

§ 371 Date: Sep. 9, 2015

Related U.S. Application Data
(60) Provisional application No. 61/785,195, filed on Mar. 14, 2013.

(51) Int. Cl. A23L 1/212

(52) U.S. Cl. CPC A23L 1/2121; A23L 1/2126; A23V 2002/00

(57) ABSTRACT

Powder compositions formed from portions of coffee cherries and methods for making same are described. Seeds (or beans) may be removed from coffee cherries to form cherry solids. The coffee cherries may include at least Arabica and Robusta coffee cherries. The cherry solids may be dried and milled to form the powder compositions. The cherry solids may be dried using various wet processing and dry processing methods. The powder compositions may be formed to have various particle sizes, such as about 105 μm (about 140 mesh) to about 44 μm (about 325 mesh) and other particular characteristics. The powder compositions may be used as a food ingredient and/or as a component of a food ingredient.

### CROSS-REFERENCE TO RELATED APPLICATIONS

This application claims the priority benefit of U.S. Provisional Patent Application No. 61/785,195, filed Mar. 14, 2013 and entitled “Flour Compositions and Food and Beverages Comprising Thereof”, which is incorporated herein by reference in its entirety.

### BACKGROUND

In coffee producing countries, coffee by-products constitute a source of contamination and environmental concern because these by-products are typically discarded after removing the coffee bean. Accordingly, it may be desirable to reduce waste from coffee by-products, particularly portions of the coffee cherry that are not used for typical coffee bean purposes, such as, for example, the pulp, the mucilage, the stem, and/or the hull.

Previous methods of reducing waste have included processing the coffee by-products for human consumption. However, these methods have been unsuccessful due to taste issues such as flavor, texture, and/or the like. These methods have also been unsuccessful due to an inability of the by-products to mix with other ingredients to form food products, an inability to comply with human and/or other animal consumption safety requirements, and/or the like.

The domestic consumption of coffee has increased about 57.6% in coffee exporting countries between 2000 and 2011. In coffee importing countries, the consumption of coffee has increased about 10.8% between 2000 and 2010. In total, world coffee production in 2011 used about 7.9 million tons of coffee beans.

To obtain the coffee beverage (“coffee”) that is widely consumed throughout the world, coffee beans or seeds must be isolated from coffee cherries and processed. The terms coffee bean and coffee seed may be used interchangeably herein. In general, there are two types of isolation processes (“coffee processing”) that are commonly used: dry processing and wet processing. Dry processing includes drying harvested coffee cherries to a moisture content of about 10% by weight to about 11% by weight. The coffee beans are separated from the material covering the beans (for example, the outer skin, pulp, parchment, and silver skin) using a de-hulling machine. Wet processing, on the other hand, does not require drying of the coffee cherries. In a wet processing method, the outer skin and the pulp are mechanically removed and the beans are fermented to remove a layer of pulp material that remains on the beans, which is about 0.5 mm to about 2 mm thick. After fermentation, the coffee beans are dried until they contain about 12% water by weight and de-hulled to remove the parchment. Typically, the bean is the only material retained for sale or storage, with the remainder of the coffee cherries being discarded, used as organic compost, or burned as fuel. The non-bean, by-product portion of a coffee cherry constitutes about 50% of the total mass of the coffee cherry. Thus, to obtain a ton of coffee beans, a ton of by-product material must be generated. With the ever-increasing consumption of coffee throughout the world, the amount of by-product has rapidly increased.

In coffee producing countries, the coffee by-products constitute a source of contamination and environmental concern. For example, the pulp and the mucilage are relatively acidic, corrosive to equipment, and difficult to dispose of efficiently and safely. Furthermore, the pulp and the mucilage can lower the pH of waterways, which could potentially be deleterious to fish and other aquatic life forms. Additionally, where the pulp is discarded in a landfill or other disposal site, rotting pulp will often generate significant odors over time. Accordingly, it may be desirable to reduce waste from coffee byproducts, particularly portions of the coffee cherry that are not used for typical coffee bean purposes, such as, for example, the pulp, the mucilage, the stem, and/or the hull.

Previous methods of reducing waste included processing the coffee byproducts for human consumption. However, these methods have been unsuccessful due to taste issues such as flavor, texture, and/or the like. These methods have also been unsuccessful due to an inability of the byproducts to mix with other ingredients to form food products, an inability to comply with human and/or other animal consumption safety requirements, and/or the like.

### SUMMARY

In an embodiment, a method of making a powder composition from a plurality of coffee cherries may include selecting a portion of the plurality of coffee cherries based on at least one first selection factor and removing a seed from each of the plurality of coffee cherries. The de-seeded plurality of coffee cherries may be dried to a moisture level of about 6% by weight to about 12% by weight. In some embodiments, drying may be performed before deseeding.

In an embodiment, the dried plurality of deseeded coffee cherries may be milled to form the powder composition having an average particle size of about 44 μm to about 105 μm and a peak viscosity of about 30 rapid visco units to about 3000 rapid visco units.

In an embodiment, a system for forming a powder composition from a plurality of coffee cherries may include a sorter configured to select a portion of the plurality of coffee cherries based on at least one first selection factor and a seed remover configured to remove a seed from each of the plurality of coffee cherries. A dryer may be configured to dry the portion of the plurality of deseeded coffee cherries to a moisture level of about 6% by weight to about 12% by weight. In some embodiments, drying may be performed before deseeding.

In an embodiment, a milling assembly may be configured to mill the portion of the plurality of deseeded coffee cherries to form the powder composition having an average particle size of about 44 μm to about 105 μm and a peak viscosity of about 30 rapid visco units to about 3000 rapid visco units.

In an embodiment, a powder composition may include comminuted dried portions of a plurality of deseeded coffee cherries. The powder composition may have an average particle size of about 44 μm to about 125 μm and a peak viscosity of about 30 rapid visco units to about 3000 visco units.

### BRIEF DESCRIPTION OF THE DRAWINGS

FIG. 1 depicts a first cross sectional view of a coffee cherry.

FIG. 2 depicts a second cross sectional view of a coffee cherry.

FIG. 3 depicts a flow diagram for an illustrative method of producing powder compositions according to some embodiments.

FIG. 4 depicts a flow diagram for an illustrative method of producing powder compositions from cherry solids obtained using a wet processing method according to some embodiments.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below.

A “coffee cherry” generally refers to one whole fruit of the coffee tree, belonging to the genus Coffea. A coffee cherry includes various portions, as described herein, including a coffee bean (or “seed”), pulp, mucilage, a hull, a stem, and the like. Species of coffee trees that produce coffee cherries include, without limitation, Coffea arabica and Coffea canephora. Beans from coffee cherries produced by the Coffea arabica tree are generally referred to as “Arabica” beans, while beans from coffee cherries produced by the Coffea canephora are generally referred to as “Robusta” beans.

A “de-seeded coffee cherry” is a coffee cherry that has had the bean portion (including the center cut and the endosperm) removed. Thus, a de-seeded coffee cherry contains all of the portions of the coffee cherry except for the bean and its constituent parts. Portions of the de-seeded coffee cherry, discussed in greater detail herein, generally include silver skin, a parchment coat, a pectin layer, pulp, an outer skin, a stem, leaves, and the like. In some embodiments, the de-seeded coffee cherry may only include certain portions of the coffee cherry and may exclude other portions in addition to the coffee bean. In some embodiments, the deseeded coffee cherry can include the outer skin, pulp, and pectin layer.

“Coffee by-products,” “by-products” and “cherry solids” generally refer to the non-bean portion of a coffee cherry. Typically, coffee producers extract and process the beans from coffee cherries and the remainder of the coffee cherries is discarded as waste or unwanted by-products. Portions of the by-products or cherry solids may be used to form compositions described according to some embodiments.

A “powder composition” generally refers to a composition formed from dried and milled non-bean portions (by-products or cherry solids) of coffee cherries. The powder composition may be formed from various non-bean portions of a coffee cherry, including, without limitation the hull, pulp, and mucilage. In some embodiments, the powder composition may be formed from various portions of a coffee cherry consisting of one or more of a hull, a pulp, and a mucilage. In some embodiments, the powder composition may be formed from various portions of a coffee cherry excluding the seed or bean. The powder composition may be formed by drying certain coffee by-products and then milling or grinding the dried coffee by-products to a certain particle size or range of particle sizes.

A “food product” is generally any edible item that is fit for consumption by humans and/or animals. The type of food product is not limited by this disclosure, and includes, for example, a baked good, a pre-fabricated good, a fried good, a chilled good, a nutritional supplement, a steamed good, a cracker, a brownie, a cake, a cake-like product, a pastry, a snack, an energy bar, a pasta, a noodle, a batter coating, a batter coated item, a bread, a cookie, a noodle, a filled food product, a flatbread, a dumpling, a steamed bun, a breaded coating, a breaded item, a cereal, and/or the like.

“Gluten-free” or “substantially gluten-free” generally refers to food products and/or any components thereof that do not contain gluten and/or contain an amount of gluten acceptable for labeling as “gluten-free” by an applicable government agency, food regulatory body, industry group, or the like. The United States Food and Drug Administration (FDA) recognizes “gluten-free” food products as not having: (1) an ingredient that is any type of wheat, rye, barley, or crossbreeds of these grains; (2) an ingredient derived from these grains and that has not been processed to remove gluten; and (3) an ingredient derived from these grains that has been processed to remove gluten, if it results in the food product containing 20 ppm or more of gluten. Other countries, such as, for example, New Zealand and Australia, permit “gluten-free” food labeling in food products having less than 3 ppm gluten. A food product that is substantially gluten-free may have a gluten content of less than or equal to about 20 parts per million (ppm), including about 15 ppm, about 10 ppm, about 5 ppm, about 3 ppm, about 1 ppm, about 0.5 ppm, about 0.1 ppm, about 0.05 ppm, 0 ppm, or any value or range between any two of these values (including endpoints). Any of the food products, solid compositions, particulate compositions, dry compositions, or the like described herein and indicated as being gluten-free will be recognized by those with ordinary skill in the art as optionally being substantially gluten-free.

Components of deseeded coffee cherries possess many potentially beneficial substances, particularly if preserved in a non-degraded (non-fermented) state. For example, fresh pulp contains high levels of polyphenol antioxidants, and fresh mucilage contains complex polysaccharides and antioxidants. The hull also contains small amounts of polyphenols, which could be used as an additional source for antioxidants. Better utilization of the by-products could make the cultivation and processing of coffee more economical.

The described powder compositions generally relate to compositions that include at least a portion of a coffee cherry by-product. The powder compositions may be formed by drying the coffee cherry by-product, for example, to a particular moisture content or a moisture content range. The dried coffee cherry by-product may be milled to a particular particle size or range of particle sizes. Non-limiting examples of coffee cherry by-products that may be used to form the powder compositions include the hull, pulp, and mucilage.

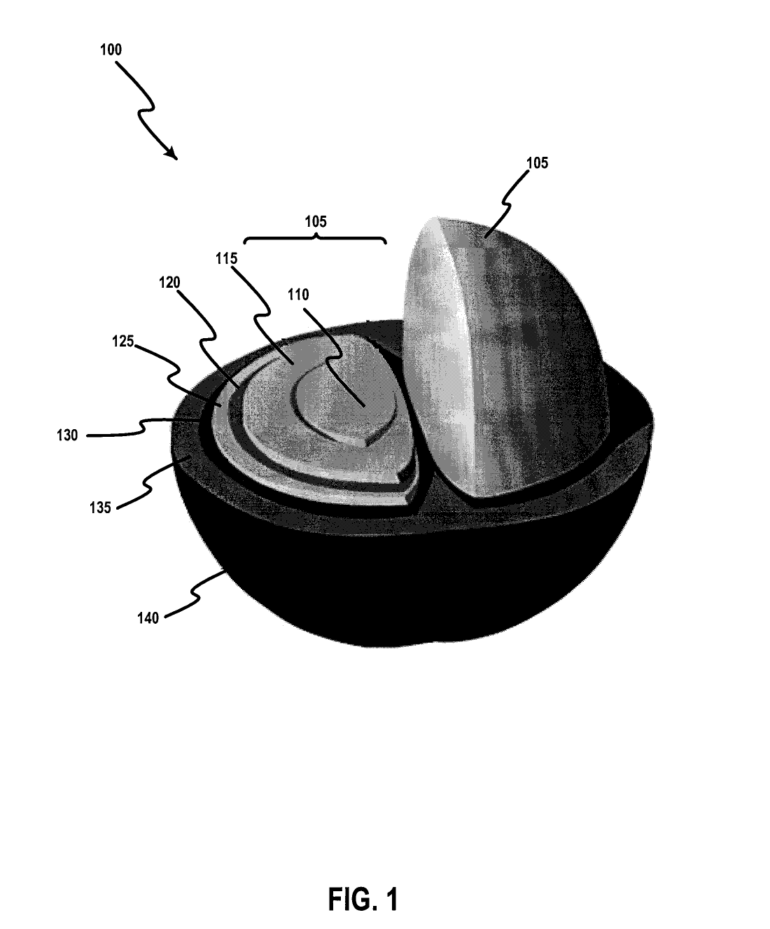

FIG. 1 depicts a first cross sectional view of a coffee cherry. The coffee cherry 100 generally includes a bean 105, which is the portion that is usually removed and processed for coffee beverages. The bean 105 may generally include a center cut 110 and an endosperm 115. The center cut 110 is generally the innermost portion of the bean 105, and the endosperm 115 is generally a portion that acts as a food store because it contains starch, protein, and other nutrients.

The remainder of the coffee cherry 100 may generally include a silver skin 120, a parchment coat 125, a pectin layer 130, a pulp 135, and an outer skin 140. The silver skin 120 may also be referred to as the epidermis. In some embodiments, the deseeded coffee cherry can include the outer skin 140, pulp 135, and pectin layer 130. The silver skin 120 is a thin tegument (covering) that is generally the innermost portion of the coffee cherry 105 that encapsulates the bean 105. The silver skin 120 is a major by-product of the roasting process to produce roasted coffee beans, and may contain high levels of antioxidants. In general, the silver skin 120 may cling to the bean 105 even after the drying process, and may be removed through various processes, such as polishing or roasting the bean. When the silver skin 120 is removed from the bean 105 during the roasting process, it is typically referred to as chaff. The parchment coat 125, which may also be known as the endocarp or the hull, surrounds the silver skin 120 with a parchment-like covering. Surrounding the parchment coat 125 is the pectin layer 130, which is a mucus-like substance. The pectin layer 130 is surrounded by the pulp 135, which is also known as the mesocarp. The pulp 135 is a fibrous mucilagenous material that is fleshy in appearance and texture. The pulp 135 may include an amount of caffeine and tannins, thus making the pulp somewhat toxic, as described in greater detail herein. The pulp 135 may be processed to remove or reduce the level of toxins. An outer skin 140 forms the outermost portion of the coffee cherry 100, which is generally a thick membrane that protects the various other contents of the coffee cherry. The outer skin 140 may sometimes be referred to as the exocarp. The coffee cherry 100 as used herein may also include other portions not specifically shown in FIG. 1A, including a stem, leaves, and/or the like.

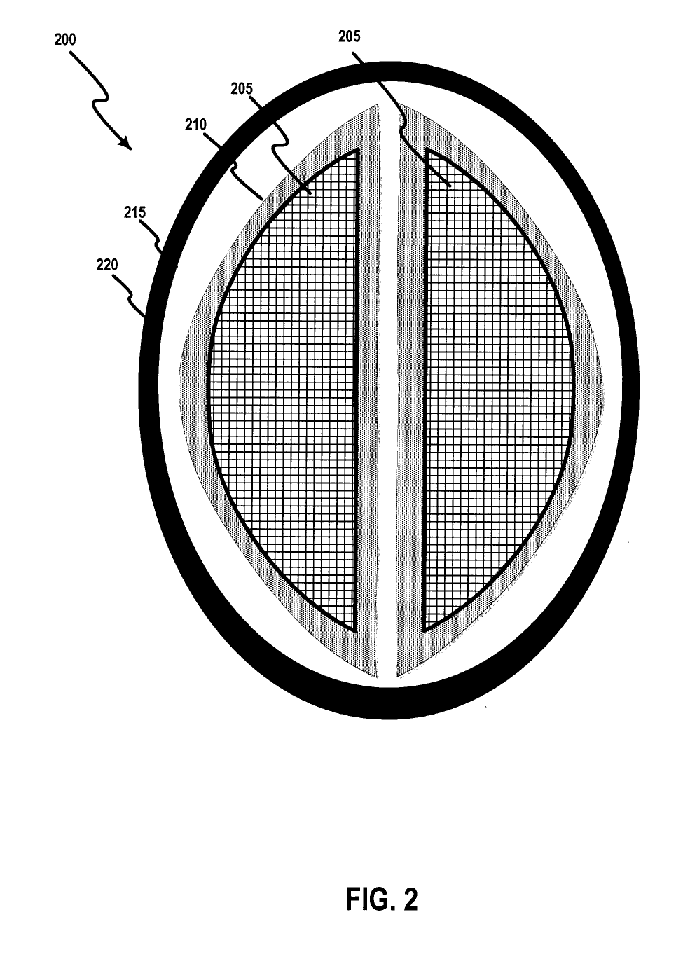

FIG. 2 depicts a second cross sectional view of a coffee cherry. As shown in FIG. 2, the coffee cherry 200 may include seeds 205 surrounded by a hull 210, a mucilage 215 and a pulp 220. The hull 210 may generally include the endocarp of the coffee cherry 200. The mucilage 215 may generally include the inner mesocarp of the coffee cherry 200. The pulp 220 may generally include at least a portion of the exocarp and the outer mesocarp of the coffee cherry 200.

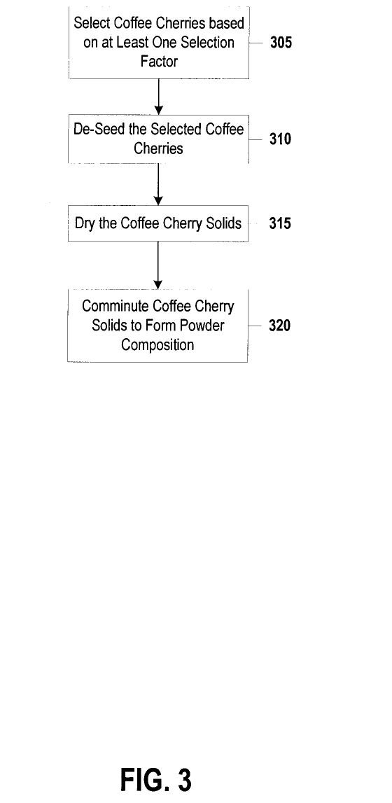

FIG. 3 depicts a flow diagram for an illustrative method of producing powder compositions according to some embodiments. The method described in reference to FIG. 3 may generally be used in whole or in part to form a powder composition. The method may include more or fewer steps and/or may be performed in a sequence different than the sequence depicted in FIG. 3.

As shown in FIG. 3, coffee cherries may be selected 305 from a population of harvested coffee cherries based on at least one selection factor. Non-limiting examples of selection factors include, color, clumping, moisture level, presence of foreign materials, presence of unwanted coffee cherry elements, ripeness (for instance, ripe, pre-ripe, over-ripe, or the like), type (for instance, Arabica or Robusta), and/or any other characteristic capable of differentiating coffee cherries. In some embodiments, coffee cherries may be selected 305 in order to achieve and/or avoid various characteristics in the powder composition, including characteristics relating to taste, texture, color, caffeine content, or the like.

The selected coffee cherries may be processed, for instance, dry processed or wet processed, and de-seeded 310. As described herein, the de-seeded 310 coffee cherries may be referred to as by-products or cherry solids. According to some embodiments, the cherry solids may include coffee cherries that are whole except for the seed or bean, which has been removed, and/or portions of coffee cherries that have been fragmented during de-seeding 310. The process for de-seeding 310 the coffee cherries may be configured according to coffee cherry de-seeding processes known to those having ordinary skill in the art. In some embodiments, de-seeding 310 may occur via a de-hulling machine, for example, configured to gently remove the coffee bean from the outer cherry skin, pulp, and other cherry solids. In some embodiments, the selected coffee cherries may be de-seeded 310 using wet processing. In some embodiments, the selected coffee cherries may be dried and manually and/or mechanically de-seeded 310. In some embodiments, drying may be performed before deseeding, while in other embodiments, deseeding may be performed before drying.

The cherry solids may be dried 315. According to some embodiments, various methods may be used to dry 315 the cherry solids. Non-limiting examples of drying methods include batch drying, horizontal batch drying (HBD), vertical batch drying (VBD), sun drying, and enhanced sun drying. The cherry solids may be dried 315 until the moisture content of the de-seeded coffee cherries and/or portions thereof reaches a target value and/or range, for instance, a percentage of moisture by weight. In particular embodiments, the cherry solids may be dried so that they contain a moisture content of about 0% by weight to about 20% by weight or about 2% by weight to about 12% by weight, including about 1% by weight, about 2% by weight, about 3% by weight, about 4% by weight, about 5% by weight, about 6% by weight, about 7% by weight, about 8% by weight, about 9% by weight, about 10% by weight, about 11% by weight, about 12% by weight, about 15% by weight, about 20% by weight, or any value or range between any two of these values (including endpoints). In particular embodiments, the cherry solids may be dried such that they contain a moisture content of about 6% by weight to about 12% by weight.

In some embodiments, HBD may generally include heating the cherry solids in a rotating device. In some embodiments, the HBD rotating device may include a rotating drum. In some embodiments, the HBD rotating device may be heated using a hot air flow configured to heat the cherry solids as they are being rotated in the HBD rotating device. In some embodiments, the temperature of the hot air flow may be about 40° C. to about 110° C. In some embodiments, the cherry solids may be placed in a staging bin or hopper above the HBD rotating device such that excess heat from the HBD rotating device may be used to pre-heat the cherry solids. During HBD, the temperature of the cherry solids may be increased from about 10° C. to about 40° C. above ambient temperature (about 20° C.). The HBD rotating device may have a capacity to dry various quantities of cherry solids, such as about 50 kilograms (kg) to about 1000 kg. In some embodiments, the cherry solids may be subjected to HBD for about 30 minutes to about 90 minutes and/or until the moisture content of the cherry solids reaches a target value. In some embodiments, the discharge temperature of the dried cherry solids may be about 30° C. to about 60° C. In some embodiments, the dried cherry solids may be cooled before further processing. In some embodiments, the cherry solids may be cooled to a temperature of about ambient temperature (about 20° C.) to about 10° C. above ambient temperature. In some embodiments, the cherry solids may be cooled to about 22° C.

In some embodiments, VBD may use an updraft resistance drier heated through a hot air flow. In some embodiments, the temperature of the hot air flow may be about 50° C. to about 100° C. In some embodiments, the cherry solids may be transferred to the updraft resistance drier using a conveyer. The conveyer may transfer the cherry solids to a top portion of the updraft resistance drier and discharge the cherry solids such that they drop through an opening in the updraft resistance drier, for example, with counter flowing hot air. Updraft resistance drier capacities may range from about 500 kg to about 2000 kg. In some embodiments, the cherry solids may be heated in the updraft resistance drier for about 30 to about 90 minutes. In some embodiments, the discharge temperature of the dried cherry solids may be about 30° C. to about 60° C. In some embodiments, the dried cherry solids may be cooled before further processing. In some embodiments, the dried cherry solids may be cooled to a temperature of about ambient temperature (about 20° C.) to about 10° C. above ambient temperature. In some embodiments, the cherry solids may be cooled to about 22° C.

The sun drying method may generally include spreading the cherry solids on a surface in a manner that allows for the decrease of the moisture content of the cherry solids. For example, the cherry solids may be spread out on an external surface such that the cherry solids are exposed to the sun. In another example, the cherry solids may be laid out on tarps on a drying patio. The tarps may be rolled up when the cherry solids are not exposed to the sun to retain heat and/or to repel moisture. In some embodiments, the cherry solids may be spread out uniformly in a single layer and/or turned over (or “raked”) in order to expose different sides of the cherry solids, for example, to facilitate efficient and uniform drying. In some embodiments, the discharge temperature of the dried cherry solids may be about 30° C. to about 50° C.

The enhanced sun drying method may generally include loading the cherry solids into a solar-heated rotating device. In some embodiments, the solar-heated rotating device may include a perforated drum. In some embodiments, the solar-heated rotating device may be heated by a solar reflector dish. The solar reflector dish may be mounted such that the solar reflector dish is able to reflect sunlight onto a portion of the solar-heated rotating device. For instance, the solar reflector dish may be mounted on an underside of the drum such that it may be exposed to sunlight and be able to reflect the sunlight to a bottom portion of the solar-heated rotating device. In some embodiments, the solar reflector dish may be configured to change positions to optimize solar exposure. The solar-heated rotating device may be rotated to facilitate efficient and uniform drying. In some embodiments, the discharge temperature of the dried cherry solids may be about 30° C. to about 50° C.

The dried cherry solids may be comminuted 320 to produce the powder composition. In some embodiments, the cherry solids may be comminuted 320 by grinding, pulverizing, milling, reduction rolling, crushing, tearing, granulating, pressing, smashing, and/or any other process capable of reducing the particle size of the cherry solids.

In some embodiments, the powder composition may include caffeine. In other embodiments, the powder composition may be caffeine-free or substantially caffeine-free. In some embodiments, the powder composition may be gluten-free or substantially gluten-free.

The powder composition and/or portions thereof may be ground to various sizes, defined by a particle size (for instance, measured in micrometers (μm)), a mesh size, a surface area, or the like. In some embodiments, the powder composition may have an average particle size of about 44 μm to about 105 μm. In some embodiments, the powder composition may have an average particle size of about 75 μm to about 105 μm. In some embodiments, the powder composition may have an average particle size of about 44 μm to about 75 μm. In some embodiments, the powder composition may have an average particle size of about 44 μm. In some embodiments, the powder composition may have an average particle size of about 0.1 μm to about 5000 μm, about 0.1 μm to about 3000 μm, or about 0.1 μm to about 200 μm. In particular embodiments, the powder composition may have an average particle size of about 0.1 μm, about 0.5 μm, about 1 μm, about 10 μm, about 25 μm, about 40 μm, about 50 μm, about 100 μm, about 150 μm, about 200 μm, about 400 μm, about 500 μm, about 1000 μm, about 2000 μm, about 3000 μm, about 4000 μm, about 5000 μm, or any value or range between any two of these values (including endpoints).

In some embodiments, the powder composition may have a coarse average particle size for shipping and transport. The coarse average particle size may be about 2000 μm to about 5000 μm, including about 2000 μm, about 2500 μm, about 3000 μm, about 4000 μm, about 5000 μm, or any value or range between any two of these values (including endpoints). In some embodiments, the powder composition may be milled at a final processing destination to produce a fine average particle size. The fine average particle size may be about 1 μm to about 400 μm, including about 1 μm, about 10 μm, about 20 μm, about 25 μm, about 40 μm, about 50 μm, about 75 μm, about 100 μm, about 200 μm, about 300 μm, about 400 μm, or any value or range between any two of these values (including endpoints).

In some embodiments, the powder composition may be reduced so that about 10% to 20% of the ground powder composition is retained by a mesh having openings with a size of about 20 mesh and so that about 80% to about 90% of the ground particulate composition is retained by a mesh having openings with a size of about 230 mesh. The mesh sizes may be standardized according to Table 1 below:

TABLE 1
MESH TO MICROMETER CONVERSION CHART

| U.S. MESH | INCHES | MICROMETERS |
|---|---|---|
| 3 | 0.2650 | 6730 |
| 4 | 0.1870 | 4760 |
| 5 | 0.1570 | 4000 |
| 6 | 0.1320 | 3360 |
| 7 | 0.1110 | 2830 |
| 8 | 0.0937 | 2380 |
| 10 | 0.0787 | 2000 |
| 12 | 0.0661 | 1680 |
| 14 | 0.0555 | 1410 |
| 16 | 0.0469 | 1190 |
| 18 | 0.0394 | 1000 |
| 20 | 0.0331 | 841 |
| 25 | 0.0280 | 707 |
| 30 | 0.0232 | 595 |
| 35 | 0.0197 | 500 |
| 40 | 0.0165 | 400 |
| 45 | 0.0138 | 354 |
| 50 | 0.0117 | 297 |
| 60 | 0.0098 | 250 |
| 70 | 0.0083 | 210 |
| 80 | 0.0070 | 177 |
| 100 | 0.0059 | 149 |
| 120 | 0.0049 | 125 |
| 140 | 0.0041 | 105 |
| 170 | 0.0035 | 88 |
| 200 | 0.0029 | 74 |
| 230 | 0.0024 | 63 |
| 270 | 0.0021 | 53 |
| 325 | 0.0017 | 44 |
| 400 | 0.0015 | 37 |

In some embodiments, the powder composition may have a particle size of about 140 mesh to about 230 mesh. In some embodiments, the powder composition may have a particle size ranging from about 20 mesh to about 230 mesh, including about 20 mesh, about 25 mesh, about 30 mesh, about 35 mesh, about 40 mesh, about 45 mesh, about 50 mesh, about 60 mesh, about 70 mesh, about 80 mesh, about 100 mesh, about 120 mesh, about 140 mesh, about 170 mesh, about 200 mesh, about 230 mesh, about 270 mesh, about 325 mesh, about 400 mesh, or any value or range between two of these values (including endpoints).

The peak viscosity of the powder composition may be measured using methods known to those having ordinary skill in the art. In some embodiments, the powder composition may be formed into a slurry and the peak viscosity of the powder composition may be measured using a rapid visco analyzer over a particular temperature range. In a non-limiting example, the powder composition may be combined with water to form a slurry containing about 5.5% particulate composition by dry weight and analyzed over a temperature range of about 60° C. to about 90° C. Alternatively, peak viscosity can be measured with the product at ambient room temperature in dry form without forming a slurry. In particular embodiments, the peak viscosity may be about 30 rapid visco units to about 3000 rapid visco units or about 200 rapid visco units to about 500 rapid visco units, including about 30 rapid visco units, about 50 rapid visco units, about 100 rapid visco units, about 200 rapid visco units, about 500 rapid visco units, about 1000 rapid visco units, about 2000 rapid visco units, about 3000 rapid visco units, or any value or range between any two of these values (including endpoints).

In some embodiments, the characteristics of the powder composition may be selected in order to achieve various qualities preferred and/or required in the powder composition for various purposes. For instance, the particle size, peak viscosity, and/or other characteristics (for example, size, color, type, ripeness, or the like) may be selected based on an intended use or uses of the powder composition, such as a particular food ingredient.

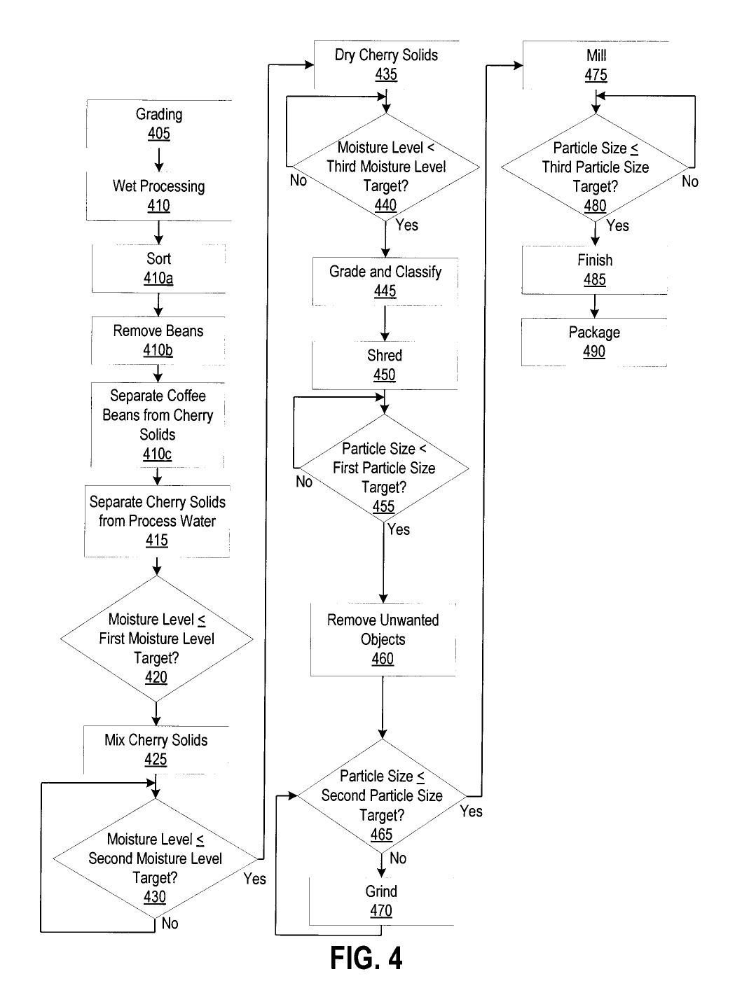

FIG. 4 depicts a flow diagram for an illustrative method of producing powder compositions from cherry solids obtained using a wet processing method according to some embodiments. The method described in reference to FIG. 4 may generally be used in whole or in part to form a powder composition. The method may include more or fewer steps and/or may be performed in a sequence different than the sequence depicted in FIG. 4.

As shown in FIG. 4, harvested coffee cherries may be graded 405 based on one or more selection factors to remove any coffee cherries that may not be usable or desirable for the purposes described herein. In some embodiments, the harvested coffee cherries may be graded based on ripeness, color, shape, size, and/or quality characteristics (for instance, indications of damage to the coffee cherry). The coffee cherries may be processed using wet processing 410 methods. During wet processing 410, the coffee cherries may be placed in a water-containing structure in which the coffee cherries are sorted 410a from unwanted materials, such as leaves, branches and foreign materials. In some embodiments, the water-containing structure may include a water flume in which the coffee cherries may be moved through the wet processing 410 steps via water conveyance. During wet processing 410, the beans may be removed 410b from the coffee cherries to form cherry solids (for instance, the non-bean components of the coffee cherries). In some embodiments, the beans may be removed 410b using a de-hulling machine. In some embodiments, the beans may be removed 410b manually and/or mechanically. During wet processing 410, the beans may be separated 410c from the cherry solids. In some embodiments, the beans may be separated 410c from the cherry solids using water flow techniques, gravity separators, filters, sieves, or any type of device capable of separating the beans from the cherry solids.

The cherry solids may be separated 415 from the process water. In some embodiments, the cherry solids may be separated 415 from the process water using a sieve or other filtering device. In some embodiments, the separated cherry solids may be transferred from the process water to a holding vessel. The cherry solids may be held in the holding vessel to drain off remaining processing water and to continue drying. In some embodiments, remaining process water may be removed using various mechanical methods, including using liquid separator devices such as centrifugal devices and/or pressure devices. In some embodiments, a liquid separator may be used to separate 415 portions of the cherry solids (for example, those that remain in the process water after the cherry solids have been transferred to the holding vessel) from the process water. In some embodiments, the liquid separator may be configured to separate certain soluble solids from the process water. In some embodiments, the liquid separator may be configured to separate pulp solids from the process water. In some embodiments, the pulp solids may be incorporated back into the cherry solids for further processing. In some embodiments, the processing water may be recycled for continued use in the wet processing 410 method.

When the moisture level of the cherry solids, for example, in the holding vessel, is less than or equal to a first moisture target level 420, the cherry solids may be mixed 425 in order to homogenize the moisture level of the cherry solids to a second moisture level target. In some embodiments, the first moisture level target may be a moisture level of about 40% by weight to about 70% by weight of the cherry solids. In some embodiments, the second moisture level target may be a moisture level of about 40% by weight to about 60% by weight.

When the moisture level of the cherry solids is less than or equal to the second moisture level target 430, the cherry solids may be dried 435. The cherry solids may be dried 435 using methods known to those having ordinary skill in the art, including HBD, VBD, sun drying, and enhanced sun drying, as described above. In some embodiments, the cherry solids may be dried 435 at a drying temperature or within a drying temperature range for a drying duration. For example, the cherry solids may be dried at a drying temperature range of about 32° C. to about 95° C. for a drying duration of about 30 minutes to about 90 minutes. In another example, the cherry solids may be dried within a drying temperature range of about 32° C. to about 54° C. for a drying duration of about 1 day to about 10 days.

The cherry solids may be dried 435 until the moisture level of the cherry solids is less than or equal to a third moisture level target 440. In some embodiments, the third moisture level target may be a moisture content of about 0% by weight to about 20% by weight. In some embodiments, the third moisture level target may be a moisture content of about 6% by weight to about 12% by weight. In some embodiments, the third moisture level target may be a moisture content of about 0% by weight, about 3% by weight, about 6% by weight, about 9% by weight, about 12% by weight, about 15% by weight, about 18% by weight, about 20% by weight, and any value or range between any two of these values (including endpoints).

The cherry solids may be graded and classified 445 to remove any components that are unwanted for the production of the powder composition. In some embodiments, unwanted components may include stems and foreign materials. In some embodiments, unwanted components may include components that are outside of specifications, including, without limitation, color, clumping, or moisture content. The cherry solids may be shredded 450 until they are within a first particle size target (for example, an average particle size range). In some embodiments, the particle size of the cherry solids may be determined using various devices configured to measure the particle size of a composition, including, without limitation a sizing machine, mesh devices, sieve devices, sifting devices, filters, and/or the like. In some embodiments, the first particle size target may be about 3360 μm (about 6 mesh or about 0.132 inches) to about 6730 μm (about 3 mesh or about 0.264 inches). In some embodiments, the cherry solids may be shredded 450 in order to increase the density of the bulk dried cherry solids material, for instance, for shipping, storage, or any other purpose. In some embodiments, the first particle size target may be configured based on subsequent processing requirements, such as grinding 470, milling 475, or the like.

When the particle size of the coffee cherry solids is less than or equal to the first particle size target 455, unwanted materials may be removed 460 from the coffee cherry solids. Non-limiting examples of unwanted materials include beans, seeds, stones, metals, clumps, materials that are not formed from a coffee cherry, and unwanted coffee cherry portions. In some embodiments, the cherry solids may be passed through a metal detection device and/or magnet device in order to detect and/or remove metal objects. In some embodiments, the cherry solids may be passed through a destoner to remove stones and/or other objects having a particular density, size, or other characteristic that distinguishes the object from the cherry solids.

A portion of the cherry solids that are not less than or equal to a second particle size target 465 may be subjected to grinding 470. In some embodiments, the second particle size target may be less than about 400 μm (about 40 mesh) to about 841 μm (about 20 mesh). In some embodiments, the second particle size target may be less than about 600 μm (about 30 mesh). Grinding 470 may be performed by various grinding devices known to those having ordinary skill in the art, such as a hammer mill, a roller mill, a disk mill, or the like. Cherry solids being ground 470 may be sifted to remove elements which may not grind properly such as silver skin, parchment, and pectin. In some embodiments, the particle size of the cherry solids being ground 470 may be re-determined and portions of the cherry solids having a particle size greater than the second particle size target may be ground again. In some embodiments, portions of the cherry solids having a particle size of about 105 μm (about 140 mesh) to about 150 μm (about 100 mesh) may be routed to finishing 485. In some embodiments, portions of the cherry solids having a particle size of about 125 μm (about 120 mesh) may be routed to finishing 490. In some embodiments, portions of the cherry solids having a particle size of about 125 μm (about 120 mesh) to about 600 μm (about 30 mesh) may be routed to milling 475.

A portion of the cherry solids that are less than or equal to the second particle size target 465 may be subjected to milling 475. In some embodiments, milling 475 may include any process configured to reduce the particle size of the cherry solids, for example, from a particle size of about 44 μm (about 325 mesh) to about 600 μm (about 30 mesh) or less. In some embodiments, milling 475 may include reduction rolling. Cherry solids being milled 475 may be sifted to remove elements which may not grind properly such as silver skin, parchment, and pectin.

A portion of the cherry solids that have a particle size less than or equal to a third particle size target 480 (the powder composition) may be finished 485. In some embodiments, the third particle target size may be about 105 μm (about 140 mesh) to about 44 μm (about 325 mesh) or less. In some embodiments, the third particle size target may be determined based on required specifications, particular uses of the powder composition, or the like. In some embodiments, finishing 485 may be configured to provide a powder composition having certain finished characteristics, including, without limitation, a particular distribution (for instance, an average or normal distribution) of particle size, particle shape and/or particle consistency. In some embodiments, the powder composition may be finished 485 using various devices configured to process the powder composition to have the finished characteristics, including a sieve, a sifter, a grinder, a milling device, or any combination thereof.

The finished powder composition may be packaged 490 using various methods, including, without limitation, paper, paper film, multilayer paper film, flexible film, corrugated containers, metal cans, plastic jars, glass jars, canisters, totes, fabric sacks. In some embodiments, the powder composition may be packaged 490 in containers ranging in size from individual single serve containers (for example, about 28 gram containers) to bulk containers (for example, about 100 kilogram containers).

According to some embodiments, grinding, milling, and/or other processing of the coffee cherry solids and/or the powder composition may be performed at a single facility or at multiple facilities. For instance, the coffee cherry solids may be ground at a first facility and milled at a second facility.

The coffee cherry and/or various portions thereof may naturally contain one or more toxins, including mycotoxins such as aflatoxins, fumonisins, ochratoxins, vomitoxins, and/or the like. Accordingly, processing may include reducing or removing toxins from the portions of the de-seeded coffee cherry. Alternatively, processing may include removing or reducing toxins from the particulate composition. The reducing or removing of toxins may improve consumers' safety and/or enable compliance with various safety regulations such as, for example, the World Health Organization's (WHO) International Programme on Chemical Safety (IPCS) or the Scientific Committee on Food (SCF) of the European Union (EU). Thus, in some embodiments, the portions of the de-seeded coffee cherry and/or the particulate composition may have an aflatoxin mycotoxin level that is less than or equal to about 20 parts per billion (ppb) for total aflatoxins, a fumonisin mycotoxin level that is less than or equal to about 2 parts per million (ppm) for total fumonisins, an ochratoxin mycotoxin level of less than or equal to about 10 ppb for total ochratoxins, and/or a vomitoxin mycotoxin level of less than or equal to about 1 ppm for total vomitoxins. In particular embodiments, the portions of the de-seeded coffee cherry and/or the particulate composition may have an aflatoxin mycotoxin level of about 20 ppb, about 15 ppb, about 10 ppb, about 5 ppb, about 1 ppb, about 0.5 ppb, about 0.1 ppb, about 0.05 ppb, 0 ppb, or any value or range between any two of these values (including endpoints). In particular embodiments, the portions of the de-seeded coffee cherry and/or the particulate composition may have a fumonisin mycotoxin level of about 2 ppm, about 1 ppm, about 0.5 ppm, about 0.1 ppm, about 0.05 ppm, about 0.01 ppm, or any value or range between any two of these values (including endpoints). In particular embodiments, the portions of the de-seeded coffee cherry and/or the particulate composition may have an ochratoxin mycotoxin level of about 10 ppb, about 5 ppb, about 1 ppb, about 0.5 ppb, about 0.1 ppb, about 0.05 ppb, about 0 ppb, or any value or range between any two of these values (including endpoints). In particular embodiments, the portions of the de-seeded coffee cherry and/or the particulate composition may have a vomitoxin mycotoxin level of about 1 ppm, about 0.5 ppm, about 0.1 ppm, about 0.05 ppm, about 0.01 ppm, or any value or range between any two of these values (including endpoints).

In particular embodiments, the powder composition may have an aflatoxin mycotoxin level of about 10 ppb to less than about 20 ppb for total aflatoxins. In particular embodiments, the powder composition may have a fumonisin mycotoxin level of about 2 ppm to less than about 5 ppm for total fumonisins. In particular embodiments, the powder composition may have an ochratoxin mycotoxin level of about 5 ppb to less than about 10 ppb for total ochratoxins. In particular embodiments, the powder composition may have a vomitoxin mycotoxin level of about 2 ppm to less about than 10 ppm for total vomitoxins.

In various embodiments, the powder composition may absorb water. The amount of water absorbed by the powder composition may be measured, for example, by placing a measured amount by weight of dry powder composition in a container with a measured amount of water, and then incubating and stirring the mixture. Excess water is drained from the mixture and the moist precipitate is weighed. A water absorption index (WAI) may be calculated according to the following:

$$WAI = \frac{mass of moist precipitate}{mass of dry particulate composition}$$

In some embodiments, the powder composition may have a water absorption index of about 1 to about 20, including about 1, about 2, about 5, about 10, about 15, about 20, or any value or range between any two of these values (including endpoints).

In various embodiments, a food product may be produced using the powder composition as a first ingredient in combination with additional ingredients including, without limitation, a fat, a flour composition, a dairy product, a flavoring agent, a leavening agent, an enzyme, a modified starch, a gum, a reducing sugar, a sweetener, a salt, and a fluid (for instance, water, oil, or other fluids appropriate for human and/or animal consumption).

### EXAMPLES

### Example 1

### Preparation of Arabica Coffee Cherry Powder Composition

An Arabica coffee cherry powder composition (the “Arabica powder composition”) was produced from Arabica coffee cherries selected from trees of the genus Coffea Arabica. About 500 kilograms of harvested Arabica coffee cherries were delivered to a coffee production plant (the “plant”) in 50 kilogram sacks. Each of the containers of coffee cherries was graded based on ripeness. Coffee cherries that were graded as ripe, based on the red color of the coffee cherry, were moved into a selected coffee cherry bin. Coffee cherries that were determined to be pre-ripe or over-ripe were moved to a rejected coffee cherry bin for use as part of a compost composition.

The selected coffee cherries were processed using dry processing in which the coffee cherries were spread in a single layer on black tarps in an open area. During the day, the coffee cherries were exposed to the sun and rotated or raked to promote even exposure. At night, the coffee cherries were rolled up in the tarps to retain heat and to prevent the formation of moisture on the coffee cherries. The coffee cherries were dried over a period of about 3 days to about 10 days, reaching temperatures of about 30° C. to about 60° C. The moisture content of the coffee cherries was monitored using spot testing of the coffee cherries until the moisture content of the coffee cherries was determined to be about 10% by weight to about 12% by weight. The coffee cherries were cooled to about 22° C.

The cooled and dried coffee cherries were transported to a de-hulling facility within the plant in which the coffee beans were removed from the coffee cherries using a de-hulling machine. The coffee beans were separated from the remaining non-bean portion of the coffee cherry (the cherry solids) by a gravity separator. The coffee beans were transported to an area in the plant for producing coffee beans for making coffee beverages. The deseeded cherry solids were transported to a powder composition facility within the plant for producing the Arabica powder composition from the cherry solids.

The cherry solids were sifted by a first sifter to remove unwanted materials, including stems, leaves, and foreign objects. The cherry solids were passed through a metal detector to detect and remove any metallic objects. The cherry solids were manually inspected to remove cherry solids that were outside of specifications for color, clumping and moisture content. A second sifter was used to remove cherry solid components that would not process properly for the Arabica powder composition, including parchment, pectin, and silver skin.

The cherry solids were shredded using a series of industrial food shredders to a particle size of about 3360 μm (about 6 mesh). The ground cherry solids were placed on variously sized screeners. Cherry solids having a particle size greater than about 3360 μm (about 6 mesh) were transported back to the food shredders for additional shredding. Cherry solids having a particle size less than about 3360 μm (about 6 mesh) were moved via a conveyer belt to a milling room having a series of reduction rollers. The cherry solids were milled by the reduction rollers to form an Arabica powder composition having an average particle size of about 75 μm (about 200 mesh). A portion of the Arabica powder composition was tested using a rapid visco analyzer by forming a 5.5% powder composition by dry weight slurry of the Arabica powder composition and water within a temperature range of about 70° C. to about 90° C. The Arabica powder composition had a peak viscosity of about 300 rapid visco units.

The 500 kilograms of harvested Arabica coffee cherries produced about 175 kilograms of the Arabica powder composition. The Arabica powder composition was packaged into about 5 kilogram bags and transported to a baking facility that used the Arabica powder composition to make a gluten-free flour for use in making gluten-free baked goods, such as bread. Accordingly, the cherry solids that were traditionally considered waste by coffee producers were formed into a useful and valuable Arabica powder composition.

### Example 2

### Preparation of a Robusta Powder Composition

A Robusta coffee cherry powder composition (the “Robusta powder composition”) was produced from Robusta coffee cherries selected from trees of the genus Coffea canephora. About 200 kilograms of ripe Robusta coffee cherries were placed in a water flume and passed through a sieve configured to separate the coffee cherries from leaves, branches, and other foreign objects. The coffee cherries were transported via water conveyance within the flume to a de-seeding area in which workers manually removed the seed or bean from the coffee cherries. The beans and the remaining non-bean portions of the coffee cherries (the cherry solids) were separated using a gravity separator. The beans were placed in containers for processing as coffee beans for making coffee beverages.

The water was removed from the cherry solids using a sieve and the cherry solids were placed in a holding vessel. The cherry solids were decaffeinated by exposing the cherry solids to steam for about 30 minutes and then rinsing the cherry solids with ethyl acetate. The steaming and ethyl acetate rinsing process was continued for about 10 hours.

The decaffeinated deseeded cherry solids were rinsed with water and placed back in the holding vessel until the cherry solids had a moisture content of about 60% by weight. The cherry solids were dried using an enhanced drying method in which the cherry solids were placed in a horizontal rotating drum. A solar reflector dish was positioned to focus the sun on the rotating drum in order to facilitate heat transfer and drying of the coffee cherries. Perforations were arranged in the rotating drum and were sized to allow water vapor to escape but to prevent the cherry solids from falling through and out of the rotating drum. The cherry solids were dried until the cherry solids had a moisture content of about 8% by weight over a period of 2 days. The discharge temperature of the dried cherry solids was about 40° C. The cherry solids were placed in a dry holding container and allowed to cool to about 25° C.

The cherry solids were moved through a series of mesh sifters configured to remove unwanted materials including foreign objects such as stones, dirt, leaves, twigs, beans, as well as unwanted cherry solid material such as parchment, pectin, and silver skin. The cherry solids were shredded in an industrial food shredder configured to shred the cherry solids to an average particle size of about 4800 μm (about 4 mesh) to form a shipping powder composition. The 200 kilograms of Robusta coffee cherries yielded about 80 kilograms of the shipping powder composition, which were packaged in 10 kilogram sacks and transported to a food ingredient production facility.

At the food ingredient production facility, the shipping powder composition was milled using a hammer mill and then a roller mill to an average particle size of about 50 μm (about 270 mesh) to form the Robusta powder composition. The Robusta powder composition was packaged in 0.5 kilogram boxes for sale in grocery stores to individual consumers as a baking ingredient, for example, to be used in place of or in combination with all-purpose flour in baked good recipes. Accordingly, the cherry solids that were traditionally considered waste by coffee producers were formed into a useful and valuable Robusta powder composition.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera As a non-limiting example, each range discussed herein can be readily broken down into a lower third, middle third and upper third, et cetera As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A method of making a powder composition from a plurality of coffee cherries, the method comprising:
selecting a portion of the plurality of coffee cherries based on at least one first selection factor;
removing a seed from each of the plurality of coffee cherries;
drying the portion of the plurality of coffee cherries to a moisture level of about 6% by weight to about 12% by weight; and
milling the portion of the plurality of coffee cherries to form the powder composition having an average particle size of about 44 μm to about 125 μm and a peak viscosity of about 30 rapid visco units to about 3000 rapid visco units, wherein milling comprises:
grinding each of the portion of the plurality of coffee cherries having the average particle size of greater than about 600 μm until the average particle size is less than about 600 μm,
reduction rolling each of the portion of the plurality of coffee cherries having the average particle size of about 125 μm to about 600 μm until the average particle size is less than about 125 μm, and
processing the portion of the plurality of coffee cherries to form the powder composition,
wherein the first selection factor comprises at least one of the following: color, clumping, moisture level, presence of foreign materials, and presence of unwanted coffee cherry elements.

2.-3. (canceled)

4. The method of claim 1, further comprising shredding each of the portion of the plurality of coffee cherries to the average particle size of about 3360 μm to about 6730 μm before grinding.

5. The method of claim 1, wherein the portion of the plurality of coffee cherries comprises one or more of a hull, a mucilage, a silverskin, a parchment coat, a pectin layer, a pulp, and an outer skin.

6. The method of claim 1, wherein the portion of the plurality of coffee cherries consists of one or more of a hull, a pulp, and a mucilage.

7. (canceled)

8. The method of claim 1, further comprising sifting the portion of the plurality of coffee cherries, wherein sifting is configured to remove at least one of the following from the portion of the plurality of coffee cherries: parchment, pectin and silver skin.

9. The method of claim 1, wherein the portion of the plurality of coffee cherries are placed in a fluid before the seed is removed from each of the portion of the plurality of coffee cherries.

10. The method of claim 9, wherein the fluid comprises water.

11. The method of claim 9, wherein the portion of the plurality of coffee cherries has a moisture content of about 40% by weight to about 60% by weight before drying.

12. (canceled)

13. The method of claim 1, further comprising selecting the plurality of coffee cherries from a set of harvested coffee cherries based on at least one second selection factor, the at least one second selection factor comprising a ripeness level.

14. The method of claim 1, further comprising selecting the plurality of coffee cherries from a set of harvested coffee cherries based on at least one second selection factor, wherein the second selection factor comprises size, shape, and color.

15. The method of claim 13, wherein the ripeness level comprises ripe, pre-ripe and over-ripe.

16. The method of claim 1, wherein the powder composition has an average particle size of about 0.1 μm to about 3000 μm.

17.-20. (canceled)

21. The method of claim 1, wherein the powder composition has a peak viscosity of about 300 rapid visco units to about 1000 rapid visco units.

22.-24. (canceled)

25. The method of claim 1, wherein drying comprises at least one of horizontal batch drying and vertical batch drying.

26.-28. (canceled)

29. The method of claim 1, wherein drying comprises sun drying.

30. (canceled)

31. The method of claim 1, wherein drying comprises heating the portion of the plurality of coffee cherries to a drying temperature of about 32° C. to about 95° C. for a drying duration.

32.-35. (canceled)

36. The method of claim 1, wherein the powder composition has a water absorption index of about 1 to about 20.

37. The method of claim 1, wherein the powder composition has mycotoxin levels of less than about 20 parts per billion for total aflatoxins, less than about 2 parts per million for total fumonisins, less than about 10 parts per billion for total ochratoxins, and less than about 5 parts per million for total vomitoxins.

38.-62. (canceled)

63. A powder composition comprising:
comminuted dried portions of a plurality of coffee cherries, wherein the powder composition has an average particle size of about 0.1 μm to about 3000 μm and a peak viscosity of about 30 rapid visco units to about 3000 visco units, wherein the plurality of coffee cherries are deseeded coffee cherries.

64. The powder composition of claim 63, wherein the comminuted dried portions comprise at least one of the following parts of the plurality of coffee cherries: a hull, a mucilage, a silverskin, a parchment coat, a pectin layer, a pulp, and an outer skin.

65. The powder composition of claim 63, wherein the comminuted dried portions consist of at least one of the following parts of the plurality of coffee cherries: pulp, mucilage and hull.

66. The powder composition of claim 63, wherein the powder composition has an average particle size of about 44 μm to about 105 μm.

67.-70. (canceled)

71. The powder composition of claim 63, wherein the powder composition has a peak viscosity of about 300 rapid visco units to about 1000 rapid visco units.

72.-74. (canceled)

75. The powder composition of claim 63, wherein the plurality of coffee cherries comprise at least one of Arabica coffee cherries or Robusta coffee cherries.

76. The powder composition of claim 63, wherein the powder composition has a water absorption index of about 1 to about 20.

77. The powder composition of claim 63, wherein the plurality of coffee cherries comprise ripe coffee cherries, pre-ripe coffee cherries, and a combination thereof.

78. The powder composition of claim 63, wherein the powder composition has mycotoxin levels of less than about 20 parts per billion for total aflatoxins, less than about 2 parts per million for total fumonisins, less than about 10 parts per billion for total ochratoxins, and less than about 5 parts per million for total vomitoxins.

79.-82. (canceled)
